(19) United States
(12) Patent Application Publication
(10) Pub. No.: US 2009/0210851 A1
(43) Pub. Date: Aug. 20, 2009

(54) LITHOGRAPHY SIMULATION METHOD AND COMPUTER PROGRAM PRODUCT

(76) Inventor: Takashi SATO, Fujisawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/370,192

(22) Filed: Feb. 12, 2009

(30) Foreign Application Priority Data
Feb. 14, 2008 (JP) 2008-033315

(51) Int. Cl. G06F 17/50

(52) U.S. Cl. 716/21; 716/5

(57) ABSTRACT

A lithography simulation method for simulating a lithography process configured to form a pattern on a wafer in which the pattern corresponds to a pattern of a photomask, the lithography process including disposing the photomask above the wafer, disposing an exposure light source above the photomask, and irradiating the wafer with light which is emitted from the exposure light source and has passed through the photomask, the lithography simulation method including assuming a light source corresponding to the exposure light source and used for simulating the lithography process, the light source failing to reflect amplitude transmittance of light emitted from the exposure light source wherein the light is obliquely incident on the photomask, and acquiring a light intensity distribution of the pattern to be formed on the wafer corresponding to the pattern of the photomask by calculation using the light source.

### CROSS-REFERENCE TO RELATED APPLICATIONS

This application is based upon and claims the benefit of priority from prior Japanese Patent Application No. 2008-033315, filed Feb. 14, 2008, the entire contents of which are incorporated herein by reference.

### BACKGROUND OF THE INVENTION

1. Field of the Invention

The present invention is related to a lithography simulation method and a computer program product used for manufacturing semiconductor device.

2. Description of the Related Art

High integration of semiconductor device is in progress. Under such circumstances, it has become important to predict a pattern to be formed on a wafer based on a photomask. Such pattern prediction is done by lithograph simulation (Jpn. Pat. Appln. KOKAI Publication No. 11-327120).

In the present circumstances, the simulation is performed under the assumption that even in a case where an incident angle of illumination light is not perpendicular to a photomask, the intensity of the illumination light is the same as the case in which it is perpendicular. This point will be further explained by using FIG. 4, as follows.

In FIG. 4, reference numeral 80 is indicative of a photomask which comprises a mask substrate 81 and a mask pattern 82 formed on the mask substrate 81. In a conventional simulation, the surface of the mask substrate 81 (pattern surface) on which side the mask pattern 82 is formed is divided into a plurality of regions (mesh) 83, and a light-emitting source 84 is further assumed in the mask substrate 81. Each mesh 83 is illuminated by lights (irradiating lights) 85 from the light-emitting source 84. Here, the intensity of lights 85 is assumed to be the same regardless of its incident angle to the mesh 83.

Meanwhile, transmitted light intensity of the illumination light with respect to the photomask changes depending on its incident angle to the photomask. If the transmitted light intensity changes, the intensity of the illumination light which strikes the photomask also changes. Along with the progress in high integration of semiconductor device, numerical aperture NA of projector lens tends to become larger. If the numerical aperture NA increases, the range of the illumination light incident angle to the photomask becomes wider.

Therefore, the conventional lithography simulation, which is performed under the assumption that light intensity is the same regardless of the incident angle, is facing a problem of difficulties in conducting highly precise pattern prediction.

This kind of problem can be solved by performing a simulation by assuming that the light-emitting source 84 shown in FIG. 4 is positioned outside the photomask 80 as it actually is. However, in order to carry out this solution, it is necessary to perform a simulation of the light propagating in the photomask 80. This simulation requires enormous calculation amount. Therefore, virtually, it is impossible to carry out the above mentioned solution.

### BRIEF SUMMARY OF THE INVENTION

According to an aspect of the present invention, there is provided a lithography simulation method for simulating a lithography process configured to form a pattern on a wafer in which the pattern corresponds to a pattern of a photomask, the lithography process comprising disposing the photomask above the wafer, disposing an exposure light source above the photomask, and irradiating the wafer with light which is emitted from the exposure light source and has passed through the photomask, the lithography simulation method comprising: assuming a light source corresponding to the exposure light source and used for simulating the lithography process, the light source failing to reflect amplitude transmittance of light emitted from the exposure light source wherein the light is obliquely incident on the photomask; and acquiring a light intensity distribution of the pattern to be formed on the wafer corresponding to the pattern of the photomask by calculation using the light source.

According to an aspect of the present invention, there is provided a computer program product stored on a computer readable medium for performing a lithography simulation for simulating a lithography process configured to form a pattern on a wafer in which the pattern corresponds to a pattern of a photomask, the lithography process comprising disposing the photomask above the wafer, disposing an exposure light source above the photomask, and irradiating the wafer with light which is emitted from the exposure light source and has passed through the photomask, the computer program product configured to store program instructions for execution on a computer system enabling the computer system to perform instructions of the lithography simulation, the instructions of the lithography simulation comprising: an instruction for assuming a light source corresponding to the exposure light source and used for simulating the lithography process, the light source failing to reflect amplitude transmittance of light emitted from the exposure light source wherein the light is obliquely incident on the photomask; and an instruction for acquiring a light intensity distribution of the pattern to be formed on the wafer corresponding to the pattern of the photomask by calculation using the light source.

### BRIEF DESCRIPTION OF THE SEVERAL VIEWS OF THE DRAWING

FIG. 1 illustrates amplitude transmittances of s polarization and p polarization.

FIG. 2 is a flow chart showing a lithography simulation method and a photomask designing method of an embodiment.

FIG. 3 shows an example of relationships between light intensity transmission rates Ts, Tp, and incident angles.

FIG. 4 illustrates a conventional lithography simulation method.

FIG. 5 illustrates a computer program product of the embodiment.

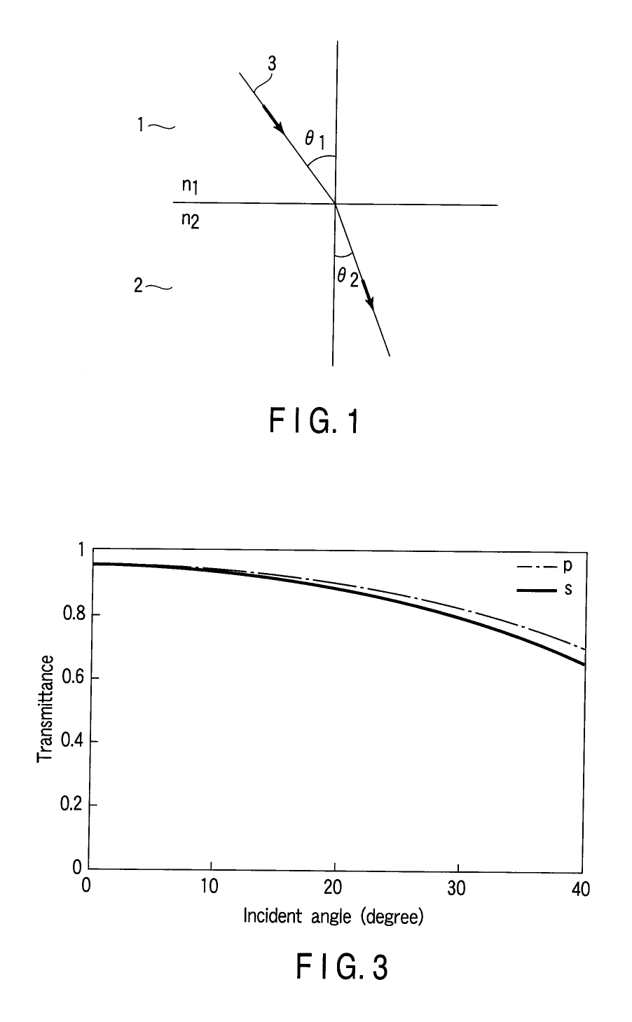

### DETAILED DESCRIPTION OF THE INVENTION

An embodiment of the present invention will be explained as follows in reference to the drawings.

### First Embodiment

A lithography simulation method of the present embodiment is a method for simulating a lithography process configured to form a pattern on a wafer in which the pattern corresponds to a pattern of a photomask. The lithography process comprises disposing the photomask above the wafer, disposing an exposure light source above the photomask, and irradiating the wafer with light which is emitted from the exposure light source and has passed through the photomask. The lithography simulation method comprises assuming a light source corresponding to the exposure light source and used for simulating the lithography process, the light source failing to reflect amplitude transmittance of light emitted from the exposure light source wherein the light is obliquely incident on the photomask; and acquiring a light intensity distribution of the pattern to be formed on the wafer corresponding to the pattern of the photomask by calculation using the light source. In addition, a lithography simulation method of the present embodiment is a product that includes instructions for enabling the computer system to perform instructions of the lithography simulation of the present embodiment.

According to the present embodiment, by using the light source in which the light to be irradiated on the wafer reflects the amplitude transmittance of the light that is incident on the photomask, the actual intensity of the light which is obliquely incident on the photomask can be reflected on the simulation. Accordingly, a highly precise pattern prediction is possible. In addition, the light source of the present embodiment can be obtained by multiplying light intensity distribution of light source (conventional light source) in which the amplitude transmittance is not reflected by the square of the amplitude transmittance. Accordingly, the increase in the calculation amount required for simulation can be suppressed.

### Second Embodiment

The second embodiment will be explained as follows.

Firstly, a case is considered in which light 3 in a medium 1 having refractive index n₁ enters a medium 2 having refractive index n₂ at incident angle θ₁ and the light 3 leaves the medium 1 at refraction angle θ₂. The medium 1 is, for example, air (n₁=1), and the medium 2 is, for example, quartz (n₂=0.96).

In the case of s polarization, the amplitude transmittance tₛ is

tₛ=2 sin θ₂ cos θ₁/sin (θ₂+θ₁) (1).

In the case of p polarization, the amplitude transmittance tₚ is

tₚ=2 sin 2θ₁/(sin 2θ₁+sin 2θ₂) (2).

Here, due to Snell's law, the following is established.

n₂ sin θ₂=n₂=n₁ sin θ₁ (3)

The ratio of refracted wave energy against incident energy, i.e. transmittance, will now be considered.

In the case of refracted light, when taking into consideration that energy density changes when incident angles and refracted angles change, the light intensity transmittance Tₛ of s polarization and the light intensity transmittance Tₚ of p polarization are respectively as follows.

Tₛ=(n₂ cos θ₂/n₁ cos θ₁)|tₛ|² (4)

Tₚ=(n₂ cos θ₂/n₁ cos θ₁)|tₚ|² (5)

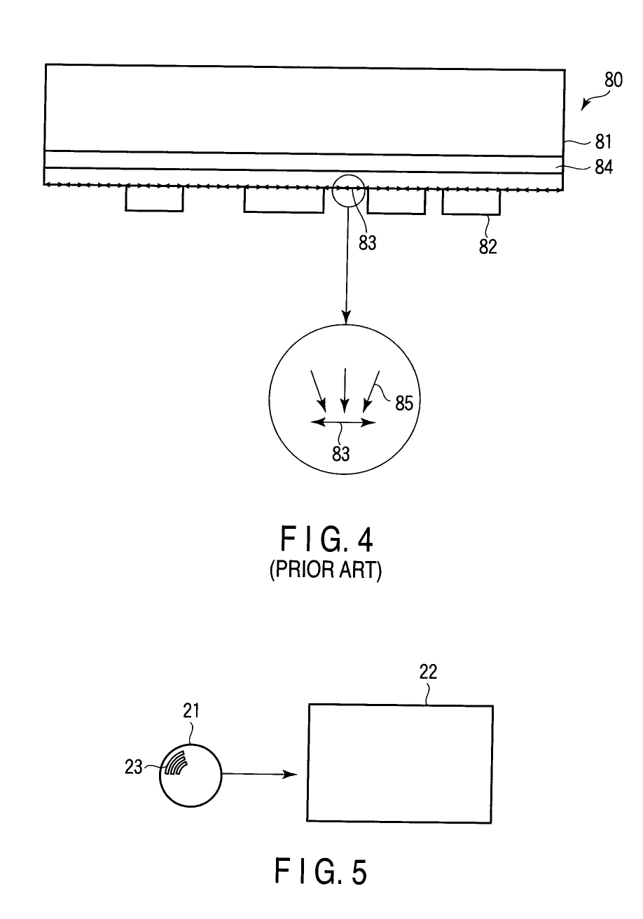

Meanwhile, upon lithography simulation, in a case of obtaining behavior of light diffraction of a mask pattern by precisely calculating a wave motion, in general, a light emitting source which emits light that illuminates the photomask and progresses to the mask pattern, is assumed to be in the mask substrate directly above the location where the mask pattern is arranged, as shown in FIG. 4.

The reason why it is assumed as such is because there is no need to simulate the behavior of wave motion in detail since the inside of mask substrate is formed of even substance, however it needs additional calculation time and additional memory consumption in calculator when the simulation for the portion is further performed. For this reason, although the actual exposure light source is arranged above the photomask, conventionally, the simulation for phenomenon of illumination light when the light above the photomask strikes the mask substrate is not performed.

Therefore, in the case where the incident angle with respect to the photomask is actually not zero, there is a change in light intensity transmittance (light intensity) in accordance with the incident angle, as shown in equations (4) and (5), conventionally, the change component of amplitude transmittance has not been taken into consideration.

However, recently, with the increase in the NA of projection lens, light components obliquely incident on the mask substrate are becoming harder to ignore. Further, even in a conventional simulation which uses an FTDT (finite difference time domain) method, the change in energy density depending on a diffraction angle has been considered. The FDTD method solves a partial differential equation (here, Maxwell equations) for each mesh divided minutely in real space.

Therefore, in the present embodiment, as the light intensity distribution of light source assumed in the mask substrate, a product obtained by multiplying the light intensity distribution of conventional light source 84 shown in FIG. 4 by the square components of the amplitude transmittances in equations (4) and (5) is used. The light intensity distribution corresponding to the s polarization is multiplied by (n₂ cos θ₂/n₁ cos θ₁)|tₛ|² in equation (4) and the light intensity distribution corresponding to the p polarization is multiplied by (n₂ cos θ₂/n₁ cos θ₁)|t_{p|}² in equation (5).

In this manner, by multiplying the light intensity distribution of light source, calculation error due to the transmittance change when the light strikes the photomask. According to the present embodiment, the simulation accuracy can be largely improved with the same calculation time or consumption amount of memory as before, since there is no need to assume the situation prior to the light being incident on the mask substrate, i.e. the light source exists above the mask substrate.

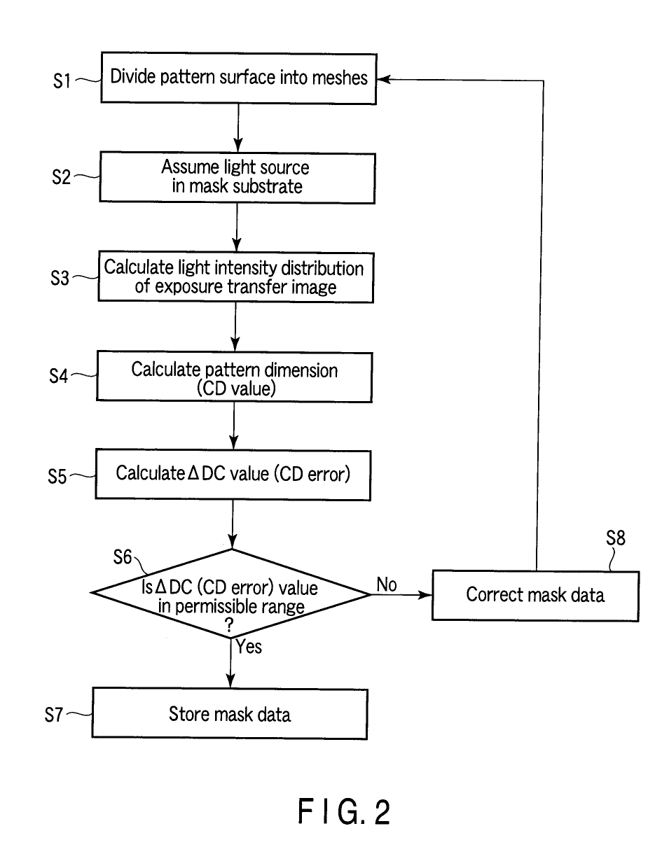

The lithography simulation method and mask designing method of the embodiment will be explained further by using the flow chart of FIG. 2.

[Step S1]

The pattern surface of a photomask is divided into a plurality of meshes.

[Step S2]

A light source is assumed in a mask substrate above the pattern surface. The light source has a light intensity distribution (amended light intensity distribution) which makes consideration of the light intensity transmittance Ts, Tp of a light source (exposure light source) actually used in exposure. That is, the light source having the light intensity distribution (amended light intensity distribution) is assumed, in which the light intensity distribution is obtained in a manner that a light intensity distribution not considering the amplitude transmittance, i.e., the intensity distribution in a case where θ1 and θ2 in the equations (4) and (5) are zero, is multiplied by the square of the amplitude transmittances in equations (4) and (5). FIG. 3 shows an example of the relationship between the light intensity transmittances Ts, Tp and the incident angles. This is an example in the case of using two pupils illumination.

Further, it is fine to reverse the order of step S1 and step S2, or perform step S1 and step S2 simultaneously.

[Step S3]

Under the condition that each mesh is irradiated with light having the amended light intensity distribution, light intensity distribution (electromagnetic field) of exposure transfer image of the photomask onto the wafer is calculated by simulation using FDTD method.

[Step S4]

A pattern dimension (Critical Dimension (CD) value) is calculated by a well-known method using the light intensity distribution of the exposure transfer image and a predetermined exposure amount threshold value (an exposure amount required to develop a resist).

[Step S5]

A ΔCD value (CD error) is calculated by comparing the calculated CD value and a design dimension. The steps up to this point (steps S1-S5) are the lithography simulation method.

[Step S6]

The ΔCD value (CD error) is determined whether or not it is within a permissible range.

[Step S7]

In the case where it is determined in step S6 that the ΔCD value (CD error) is within the permissible range, data related to the above mentioned photomask (mask data) is stored as mask data used in the production of an actual photomask. The mask data is, for example, design data of the above mentioned photomask, or is the design data converted into data used in an exposure device.

[Step S8]

In the case where it is determined in step S6 that the ΔCD value (CD error) is outside the permissible range, the mask data is corrected by a well-known method.

Subsequently, the step jumps back to step S1 and performs steps S2-S5 again. In step S6, determination is carried out again. In the case where it is determined in step S6 that the ΔCD value (CD error) is outside the permissible range, the steps of S8 and S1-S5 is repeated over a predetermined number of times until it is determined in step S6 that the ΔCD value (CD error) is within the permissible range. In the case where it is determined in step S6 that the ΔCD value (CD error) is outside the permissible range even after repeating the steps over the predetermined number of times, the simulation is canceled. Steps up to this point are the photomask designing method.

A manufacturing method of the photomask in the embodiment will be explained as follows.

Firstly, a light shielding film is formed on a transparent substrate. The light shielding film is a film which has lower transmittance against an exposure light in comparison to the transparent substrate. The transparent substrate is, for example, a quartz substrate. The light shielding film is, for example, a chrome (Cr) film or a molybdenum silicide film (halftone). Instead of forming the light shielding film on the transparent substrate, it is also fine to prepare a substrate which includes a transparent substrate and a light shielding film formed thereon (mask blanks).

Next, a resist film is formed on the light shielding film.

Next, the resist film is exposed using an exposure apparatus, such as an electron beam exposure apparatus, and the mask data stored in step S6.

Next, the exposed resist film is developed, and a resist pattern is formed.

Next, the light shielding film is etched by using the resist pattern as a mask, to form a mask pattern made of the light shielding film. In this manner, a photomask which includes the transparent substrate and the mask pattern arranged on the transparent substrate is obtained.

A manufacturing method of a semiconductor equipment of the embodiment will be explained as follows.

Firstly, a resist is applied on a substrate including a semiconductor substrate. The semiconductor substrate is, for example, a silicon substrate or SOI substrate.

Next, the photomask manufactured by the method used in the embodiment is arranged above the substrate, the resist is irradiated with light or charged beam via the photomask, thereafter development is performed to form a resist pattern.

Next, the substrate is etched using the resist pattern as a mask to form a fine pattern. Thereafter, the resist pattern is removed.

Here, in the case where the underlying layer (the uppermost layer of the substrate) of the resist is a polycrystalline silicon film or a metal film, a fine electrode pattern or wiring pattern etc. is formed. In the case where the underlying layer (the uppermost layer of the substrate) of the resist is an insulating film, a fine contact hole pattern or gate insulating film etc. is formed. In the case where the underlying layer of the resist is the semiconductor substrate, a fine isolation trench (STI) etc. is formed.

The semiconductor device is manufactured by repeating the above mentioned procedures of applying a resist, forming a resist pattern and etching a substrate to form a required fine pattern.

FIG. 5 shows a computer program product of the embodiment. The computer program product 21 record a program 23 for enabling the system including a computer 22 to execute the lithography simulation method or the photomask designing method of the embodiment.

The computer program product 22 is, for example, a CD-ROM or DVD.

The program 23 includes instructions corresponding to steps S1-S6 (lithography simulation method) in FIG. 2, and instructions corresponding to steps S1-S8 (photomask designing method) in FIG. 2.

The program 23 is executed by using hardware resources, such as a CPU and memory in the computer 22 (in some cases, an external memory is used together). The CPU reads necessary data from the memory and performs the above steps on the data. The result of each step is stored temporarily in the memory according to need and read out when it becomes necessary by other instructions.

Further, the present invention is not limited to the above embodiments. For example, in the above embodiment, a case of a simulation using FDTD method is explained. However, the present invention can also be applied to simulations which use RCWA (rigorous coupled wave analysis) method. The RCWA method solves a partial differential equation (here, Maxwell equations) in Fourier space. Further, the present invention can also be applied to simulations which use waveguide method. That is, the present invention can be applied to simulations adopting a model in which a plurality of meshes for dividing the pattern surface of a mask substrate are assumed to be provided in the mask substrate, and each of the plurality of meshes is irradiated with light having the same light intensity distribution.

In addition, the lithography simulation method/computer program product of the embodiment may also be carried out as a lithography simulation method/computer program product incorporated as a part of an OPC simulation method/computer program product, and not as a single independent lithography simulation method/computer program product for obtaining a ΔCD value (CD error).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A lithography simulation method for simulating a lithography process configured to form a pattern on a wafer in which the pattern corresponds to a pattern of a photomask, the lithography process comprising disposing the photomask above the wafer, disposing an exposure light source above the photomask, and irradiating the wafer with light which is emitted from the exposure light source and has passed through the photomask,
the lithography simulation method comprising:
assuming a light source corresponding to the exposure light source and used for simulating the lithography process, the light source failing to reflect amplitude transmittance of light emitted from the exposure light source wherein the light is obliquely incident on the photomask; and
acquiring a light intensity distribution of the pattern to be formed on the wafer corresponding to the pattern of the photomask by calculation using the light source.

2. The lithography simulation method according to claim 1, wherein the photomask comprises a mask substrate having a main surface and a pattern provided on the main surface, the light source includes a light intensity distribution obtained by multiplying a light intensity distribution of a light source not having been reflected the amplitude transmittance by square of the amplitude transmittance.

3. The lithography simulation method according to claim 2, wherein the acquiring the light intensity distribution of the pattern includes dividing the main surface into a plurality of regions, and acquiring electromagnetic field for each of the plurality of regions by calculation.

4. The lithography simulation method according to claim 3, wherein the acquiring the light intensity distribution of the pattern is performed by using FDTD method, RCWA method or waveguide method.

5. The lithography simulation method according to claim 2, further comprises calculating dimensions of the pattern to be formed on the wafer corresponding to the pattern of the photomask using the acquired light intensity distribution, and calculating difference between the calculated dimensions of the pattern and a design dimensions.

6. The lithography simulation method according to claim 5, further comprises determining whether the calculated difference is within a permissible range or not.

7. The lithography simulation method according to claim 5, wherein the calculated dimensions of the pattern is a CD value.

8. The lithography simulation method according to claim 2, wherein the amplitude transmittance is (n₂ cos θ₂/n₁ cos θ₁)|tₛ|² in a case of s polarization, and the amplitude transmittance is (n₂ cos θ₂/n₁ cos θ₁)|tₚ|² in case of p polarization.

9. A computer program product stored on a computer readable medium for performing a lithography simulation for simulating a lithography process configured to form a pattern on a wafer in which the pattern corresponds to a pattern of a photomask, the lithography process comprising disposing the photomask above the wafer, disposing an exposure light source above the photomask, and irradiating the wafer with light which is emitted from the exposure light source and has passed through the photomask, the computer program product configured to store program instructions for execution on a computer system enabling the computer system to perform instructions of the lithography simulation,
the instructions of the lithography simulation comprising:
an instruction for assuming a light source corresponding to the exposure light source and used for simulating the lithography process, the light source failing to reflect amplitude transmittance of light emitted from the exposure light source wherein the light is obliquely incident on the photomask; and
an instruction for acquiring a light intensity distribution of the pattern to be formed on the wafer corresponding to the pattern of the photomask by calculation using the light source.

10. The computer program product to claim 9, wherein the photomask comprises a mask substrate having a main surface and a pattern provided on the main surface, the light source includes a light intensity distribution obtained by multiplying a light intensity distribution of a light source not having been reflected the amplitude transmittance by square of the amplitude transmittance.

11. The computer program product according to claim 10, wherein the instruction for acquiring the light intensity distribution of the pattern includes dividing the main surface into a plurality of regions, and acquiring electromagnetic field for each of the plurality of regions by calculation.

12. The computer program product according to claim 11, wherein the instruction for acquiring the light intensity distribution of the pattern is performed by using FDTD method, RCWA method or waveguide method.

13. The computer program product according to claim 10, further comprises an instruction for calculating dimensions of the pattern to be formed on the wafer corresponding to the pattern of the photomask using the acquired light intensity distribution, and an instruction for calculating difference between the calculated dimensions of the pattern and a design dimensions.

14. The computer program product according to claim 13, further comprises an instruction for determining whether the difference is within a permissible range or not.

15. The computer program product according to claim 13, wherein the instruction for calculated dimensions of the pattern is a CD value.

16. The computer program product according to claim 10, wherein the amplitude transmittance is (n₂ cos θ₂/n₁ cos θ₁)|tₛ|² when the light intensity distribution corresponds to s polarization, and the amplitude transmittance is (n₂ cos θ₂/n₁ cos θ₁)|tₚ|² when the light intensity distribution corresponds to p polarization.
